(19) United States
(12) Patent Application Publication
(10) Pub. No.: US 2002/0078465 A1
(43) Pub. Date: Jun. 20, 2002

(54) Method of providing high-speed digital services over a switched telephone network

(76) Inventors: Thomas Anthony Stahl, Indianapolis, IN (US); John William Richardson, Hamilton, NJ (US)

Correspondence Address: THOMSON MULTIMEDIA LICENSING INC, JOSEPH S TRIPOLI, PO BOX 5312, 2 INDEPENDENCE WAY, PRINCETON, NJ, 08543-5312, US

(21) Appl. No.: 09/741,234

(22) Filed: Dec. 20, 2000

(51) Int. Cl. H04L 12/66; H04Q 11/00; H04L 12/50; H04N 7/173; H04N 7/16

(52) U.S. Cl. 725/106; 370/357; 370/355; 370/358; 725/143

(57) ABSTRACT

The present method provides a fixed bandwidth for communicating information by way of a DSL service over a circuit switched telephone network. It includes the steps of setting a transmission bandwidth at a transmitting end of a DSL service over a circuit switched telephone network; dividing out the desired transmission bandwidth into multiple data connections each corresponding to an available voice connection in the circuit switched telephone network; delivering information at the desired transmission bandwidth by way of the multiple data rate connections; and combining the multiple data connections at a receiving end of the DSL service to provide the information at the desired transmission bandwidth.

### FIELD OF THE INVENTION

The present invention generally relates to network communications and, more particularly, to a method of providing high bandwidth digital communications over a circuit switched telephone network.

### BACKGROUND OF THE INVENTION

Changing communications demands are transforming the existing public information network from one limited to voice, text and low resolution graphics to bringing multimedia, including full motion video, to everyone's home. A key communications transmission technology that is enabling transformation of existing public information networks to accommodate higher bandwidth needs is Asymmetric Digital Subscriber Line (ADSL), a modem technology. ADSL converts existing twisted-pair telephone lines into access paths for multimedia and high-speed data communications. ADSL can transmit up to 8 Mbps (Megabits per second) to a subscriber, and as much as 960 kbps (kilobits per second) or more in both directions. Such rates expand existing access capacity by a factor of 50 or more without new cable installations.

Asymmetric Digital Subscriber Line ADSL technology involves modems attached across twisted pair copper wiring in which transmission rates from 1.5 Mbps to 8 Mbps downstream (to the subscriber) and from 16 kbps to 9600 kbps upstream (from the subscriber), depending on line distance, can be achieved. Asynchronous transfer mode ATM is an ultra high-speed cell based data transmission protocol that may be run over ADSL. A Digital Subscriber Line Access Multiplexer (DSLAM) is a device that takes a number of ADSL subscriber lines and concentrates them to a single ATM line. Plain old telephone service POTS refers to basic analog telephone service. POTS takes the lowest 4 kHz bandwidth on twisted pair wiring. Any server sharing a line with POTS must either use frequencies above POTS or convert POTS to digital and interleave with other data signals.

Currently, there is not an effective solution for guaranteeing adequate bandwidth transmission for the support of real-time video between consumers. Solutions that exist today are based upon leased lines, ISDN, or make use of the Internet. The fixed nature of the leased-line link does not provide a guaranteed amount of fixed bandwidth between the two end-points. Also, because the leased-line is physically fixed, it does not allow flexible connecting to another premise. This is because the line is physically fixed. The ISDN method has the disadvantages of cost, multiple connections for higher bandwidth, and a lack of flexibility for dynamically allocating the bandwidth. The third method, a packet-based network such as the Internet is disadvantageous because the Internet is designed as a best-effort service model. With the Internet it is nearly impossible to guarantee any specific amount of bandwidth or to put a bound on end-to-end delay variation for any particular service or application. For example, video and email are both treated with the same importance. Even though video is time and jitter sensitive, the Internet does not distinguish between these two different types of traffic. Time and jitter sensitive information such as video has much more stringent transmission requirements than that of e-mail. Several initiatives to change the Internet from being a best effort network to one that can differentiate between the multiple types of traffic have failed and are not likely to become a reality in the immediate future. Currently, it is nearly impossible to offer guaranteed bandwidth for transmission of real-time video between consumers. The Internet is also problematic in that it simply does not have the capacity for a large rollout of a point-to-point streaming types service.

Accordingly, there is a need for transporting time and jitter sensitive information, such as real-time video, in a point-to-point fashion across multiple voice channels in switched telephone network.

### SUMMARY OF THE INVENTION

The present method of provides a fixed bandwidth for communicating information by way of a DSL service over a circuit switched telephone network. The includes setting a transmission bandwidth at a transmitting end of a DSL service over a circuit switched telephone network; dividing the desired transmission bandwidth into multiple data connections, each corresponding to an available voice connection in the circuit switched telephone network; delivering information at the desired transmission bandwidth by way of the multiple data connections, and combining the multiple data connections at a receiving end of an identical DSL service to provide the information at the desired transmission bandwidth.

There is also provided a DSL system for providing a fixed bandwidth for communicating information by way of interconnections over a circuit switched telephone network. The DSL system includes a DSL connection over a local loop capable of providing multiple voice connections each at a predefined bandwidth; a first DSL access unit for dividing a transmission bandwidth into multiples of the predefined bandwidth transmitted over the DSL connection; and a second DSL access unit for receiving the multiples of the predefined bandwidth over the circuit switched network and combining the multiples of the predefined bandwidth to provide the transmission bandwidth.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary digital subscriber line (DSL) system architecture capable of offering integrated multi-line telephony services such as voice, data and video.

FIG. 2 is a block diagram of the inventive use of a switched telephone network to provide guaranteed bandwidth or constant bit rate for high data rate transfer (such as video phone communication) over DSL services.

It should be understood that the drawings are for purposes of illustrating the concepts of the invention and are not necessarily the only possible configuration for illustrating the invention.

### DETAILED DESCRIPTION OF THE INVENTION

The present invention is a method of transporting time and jitter sensitive information, such as real-time data, video or audio, in a point-to-point fashion by spanning such traffic across multiple 64 kilobytes per second voice channels in the public switched telephone network PSTN. The invention uses an interface for time-slot management to a class 5 PSTN switch and control within an ADSL system. The invention exploits the capabilities of the PSTN to carry information other than voice data and it takes advantage of the guaranteed bandwidth properties of a circuit-switched network. The advantage of using a circuit switched network is the ability to guarantee a fixed amount of capacity or bandwidth with 64 kbps (kilobits per second) increments while only incurring a small amount of fixed delay. The invention also guarantees minimal end-to-end delay variation.

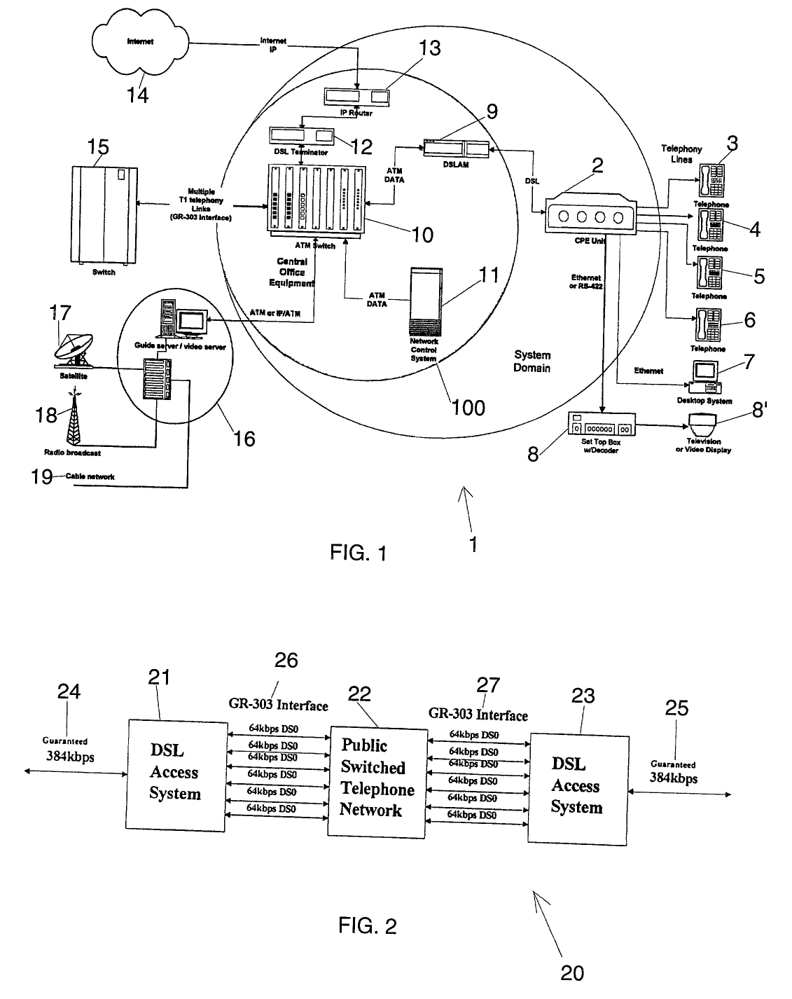

A DSL system architecture 1 for integrating voice, data and video services, shown in FIG. 1, is presented as an exemplary DSL environment for employing the inventive method of enabling video phone communication and similar multimedia communication over a DSL link. Details of the individual block components making up the system architecture are known to skilled artisans, and will only be described in details sufficient for an understanding of the invention. The system block diagram 1 is composed of several functional blocks. The system domain is composed of Central Office (CO) Equipment 100 and Customer Premise Equipment (CPE). The component blocks within the system domain and their respective interfaces are: customer premise equipment (CPE), Digital Subscriber Line Access Multiplexer (DSLAM) 9, an ATM switch 2, an IP router 13 and DSL terminator 12, and a network control system (NCS) 11.

The current customer premise equipment (CPE) 2 includes a DSL modem unit that interfaces with four separate analog telephones 3-6 over a plain old telephone service (POTS), a 10Base-T Ethernet connection to a PC desktop system 7, and an Ethernet or RS-422 connection to a set-top box with a decoder 8 for connection to a television or video display 8′. From the customer's analog end, the CPE device 2 accepts the analog input from each of the telephones 3-6, converts the analog input to digital data, and packages the data into ATM packets (POTS over ATM), with each connection having a unique virtual channel identifier/virtual path identifier (VPI/PCI). Known to skilled artisans, an ATM is a connection oriented protocol and as such there is a connection identifier in every cell header which explicitly associates a cell with a given virtual channel on a physical link. The connection identifier consists of two sub-fields, the virtual channel identifier (VCI) and the virtual path identifier (VPI). Together these identifiers are used at multiplexing, demultiplexing and switching a cell through the network. VCIs and VPIs are not addresses, but are explicitly assigned at each segment link between ATM nodes of a connection when a connection is established, and remain for the duration of the connection. When using the VCI/VPI, the ATM layer can asynchronously interleave (multiplex) cells from multiple connections.

The Ethernet data is also encapsulated into ATM cells with a unique VPI/VCI. The ATM cell stream is sent to the DSL modem to be modulated and delivered to the DSLAM unit 9.

Going in the other direction, the DSL signal is received and demodulated by the DSL modem in the customer premise equipment 2 and delivered to VPI/VCI detection processing. The ATM cell data with VPI/VCI matching that of the end user's telephone is then extracted and converted to analog POTS to be delivered to the telephone. The ATM cell data with VPINCI matching that of the end user's Ethernet is extracted and delivered to an Ethernet transceiver for delivery to the port.

The Digital Subscriber Line Access Multiplexer DSLAM 9 demodulates data from multiple DSL modems and concentrates the data onto the ATM backbone network for connection to the rest of the network. That DSLAM provides back-haul services for package, cell, and/or circuit based applications through concentration of the DSL lines onto ATM outputs to the ATM switch 10.

The ATM switch 10 is the backbone of the ATM network. The ATM switch 10 performs various functions in the network, including cell transport, multiplexing and concentration, traffic control and ATM-layer management. Of particular interest in the system domain 100, the ATM switch provides for the cell routing and buffering in connection to the DSLAM, network control system 11 and the Internet gateway (Internet Protocol IP router 13 and DSL terminator 12), and T1 circuit emulation support in connection with the multiple telephony links switch 15. A T1 circuit provides 24 voice channels packed into a 193 bit frame transmitted at 8000 frames per second. The total bit rate is 1.544 Mbps. The unframed version, or payload, consists of 192 bit frames for a total rate of 1.536 Mbps.

The ATM switch 10 is shown coupled to a program guide server/video server 16 to satellite 17, radio broadcast 18 or cable 19 networks. The ATM switch 10 is also coupled over the DSL terminator 12 and IP router 13 pair to receive Internet Protocol IP packet data from the Internet 14.

The network control system 100 provides for address translation, demand assignment and call management functions. The Network Control System's principle function is to manage the DSL/ATM network including the origination and termination of phone calls. The NCS is essentially the control entity communicating and translating control information between the class 5 PSTN switch (using the GR-303 protocol) and the CPE. The network control system 100 is available for other functions such as downloadable code to the CPE, and bandwidth and call management (e.g., busy) functions, as well as other service provisioning and set up tasks.

Turning now to FIG. 2, the block diagram 20 illustrates the use of a switched telephone network to provide guaranteed bandwidth with a constant bit rate between DSL access systems such as the DSL system architecture of FIG. 1. At one end a guaranteed 384 kbps 24 over a DSL access system 21 can be achieved by aggregating 6 multiple and separate 64 kbps DSO digital voice transmission bands 26, 27 over a public switched telephone network PSTN 22, coupled to another DSL access system 23 to provide a guaranteed 384 kbps at the other end. The GR-303 interfaces 26, 27, refer to a known standard that specifies the requirements for interfacing an integrated digital loop carrier (IDLC) to a telephone switch. The DSL system emulates a digital loop carrier and uses the same signaling channels and protocols. There are two types of signaling channels used in the GR-303 interface: a time slot management channel (TMC) and an embedded operations channel (EOC). The TMC is the signaling channel used to dynamically allocate time slots are T1 channel. The EOC is the signaling channel used for alarm and management functions.

Due to the nature of the signaling used on a T1 circuit using an extended super frame (ESF) format in GR-303, the 64 kbps channel allows for only 56 kbps data and the remaining 8 kbps for supervising signaling. The 8 kbps for supervising signaling includes on-hook, off-hook, ringing, etc. This information is conveyed through in-band signaling rather than out-of-band signaling. The call setup and teardown is conveyed through the out-of-band signaling.

Each of these 64 kbps connections 26, 27 and the DSL system is represented as a voice connection with an associated phone number. The PSTN treats them as normal voice calls and does not know the difference. However, from the PSTN's point of view, a separate phone number would be associated with each 64 kbps connection. The CPEs in cooperation with the NCS would be responsible for generating and terminating multiple phone connections when video communications is desired. Not that in this case, we are referring to a video phone call, not the broadcast video illustrated by 16 in FIG. 1. Also note that the CPE (or a piece of customer equipment hooked to the CPE) would need to provide interfaces for video-in and video-out. These could be standard NTSC video interfaces such as those found on camcorders and TVs.

For a typical video call, phone numbers can be allocated as follows: let x be the phone number that the originator calls and let y be the phone number of the originating video call. The user only needs to know that they are calling from y to x. But the DSL system (customer premise equipment 2 in cooperation with the network control system 11) actually places N calls from y to x, y+1 to x+1, . . . , y+N−1 to x+N−1. An example would be when 6 originating numbers (e.g., 587-6000, 587-6001, . . . , 587-6005 are connected to 842-5010, 842-5011, . . . , 842-5015. This is all handled by the DSL system's customer premise equipment 2 and the network control system 11. It is totally transparent to the public switched telephone network PSTN. In this example, 384 kbps of bandwidth has been allocated. Call origination and tear-down would be special commands sent from the customer premise equipment 2 to the network control system 11. The numbers can all be provisioned by the provider of this service, and could be transparent to the customer. Alternatively, there could be manual provisioning of the numbers, and the customer could enter six numbers for each destination videophone that they may call.

The video compression transmitted over the multiple 64 kbps bands can be MPEG4, H.263, H.621 or any other video compression standard suitable for a constant bit rate channel and the approximate rates described above. It would be desirable to use a video coding standard that allows for bandwidth adjustment, at least in 64 kbps increments. In this way, if the DSL link at either end of the connection becomes heavily loaded by traffic associated with another service, the end systems could negotiate the dropping of several channels. For example, a video connection that uses six channels (384 kbps) may drop down to five channels (320 kbps).

More specifically, with respect to the DSL system architecture of FIG. 1, the originating customer premise equipment unit 2 CPE would operate as a first DSL access system 21 and the Central office equipment 100 would provide the connection 26 to the PSTN 22. The terminating CPE 2 would operate as the second DSL access system 23. A guaranteed 384 kbps bandwidth would be provided over the local loop between the customer premises equipment unit 2 and the Digital Subscriber Line Access Multiplexer DSLAM 9. Essentially, the bandwidth requirements over the public switched telephone network between the CO equipment 100 associated with the originating CPE 2 and the CO equipment 100 associated with the terminating CPE 2 are provided by multiple 64 kbps digital representations of voice (DSO).

It can be appreciated from the above that the invention exploits the capabilities of a voice enabled DSL network that interfaces to the public switched telephone network PSTN. The voice enabled DSL network is capable of set up and tear down of voice connections on a demand basis. Each one of these voice connections is a 64 kbps (kilo bits per second) link or timeslot of a circuit switched network with a fixed and guaranteed amount of bandwidth. This capability of demand connections that one can readily set up and tear down can be leveraged by employing simultaneous multiple voice connections from a single source to a single destination. This allows N connections between two points to create an aggregate bandwidth of N×64 kbps. Because these connections are set up on a circuit switched network, there can be a guaranteed amount of fixed capacity in 64 kbps increments and minimal amount of end-to-end delay variation while incurring a small amount of fixed delay is also guarantee.

Although the embodiment which incorporates the teachings of the present invention has been shown and described in detail herein, those skilled in the art can readily devise many other varied embodiments that still incorporate these teachings.

We claim:

1. A method of providing a fixed bandwidth for communicating information by way of a DSL service over a circuit switched telephone network comprising:
setting a transmission bandwidth at a transmitting end of a DSL service over a circuit switched telephone network;
dividing out said desired transmission bandwidth into multiple data rate connections each corresponding to an available voice connection in said circuit switched telephone network;
delivering information at said desired transmission bandwidth by way of said multiple data rate connections; and
combining said multiple data rate connections at a receiving end of said DSL service to provide said information at said desired transmission bandwidth.

2. A method according to claim 1, wherein said voice connection in said circuit switched telephone network is a 64 kbps connection.

3. A method according to claim 1, wherein each of said multiple data rate connections over which said information is delivered over a 64 kbps connection.

4. A method according to claim 1, wherein said transmission bandwidth is 384 kbps.

5. A method according to claim 4, wherein each of said multiple data rate connections is a 64 kbps voice connection over said circuit switched telephone network.

6. A method according to claim 4, wherein said multiple data rate connections are 6 voice connections at a rate of 64 kbps over said circuit switched telephone network.

7. A method according to claim 1, wherein each of said multiple data rate connections is a distinct phone number connection between said transmitting end and said receiving end.

8. A method according to claim 1, wherein said step of dividing out said desired transmission bandwidth is carried out by a digital subscriber line access multiplexer in a DSL system.

9. A method according to claim 9, wherein said step of combining said multiple data rate connections is carried out by a DSL modem.

10. A DSL system for providing a fixed bandwidth for communicating information by way of interconnections over a circuit switched telephone network, said DSL system comprising:
a DSL connection over a circuit switched telephone network capable of providing multiple voice connections each at a predefined bandwidth;
a first DSL access unit for dividing out a transmission bandwidth into multiples of said predefined bandwidth transmitted over said DSL connection; and
a second DSL access unit for receiving said multiples of said predefined bandwidth over said circuit switched network and combining said multiples of said predefined bandwidth to provide said transmission bandwidth.

11. A DSL system according to claim 10, wherein said predefined bandwidth is 64 kbps.

12. A DSL system according to claim 10, wherein said first DSL access unit is a digital subscriber line access multiplexer (DSLAM).

13. A DSL access system according to claim 12, wherein said second DSL access unit is a DSL modem.

14. A DSL system according to claim 10, wherein said second DSL access unit is a digital subscriber line access multiplexer (DSLAM).

15. A DSL access system according to claim 14, wherein said first DSL access unit is a DSL modem

16. A DSL system according to claim 10, wherein said transmission bandwidth is 384 kbps.

17. A DSL system according to claim 16, wherein each of said multiples of said predefined bandwidth is 64 kbps.
